(19) United States
(12) Patent Application Publication
(10) Pub. No.: US 2021/0309415 A1
(43) Pub. Date: Oct. 7, 2021

(54) Subterranean Storage Container

(71) Applicant: Marcal F. DaCunha, Middletown, NJ (US)

(72) Inventor: Marcal F. DaCunha, Middletown, NJ (US)

(21) Appl. No.: 14/604,741

(22) Filed: Jan. 25, 2015

Related U.S. Application Data
(60) Provisional application No. 61/965,180, filed on Jan. 27, 2014.

(51) Int. Cl. B65D 25/20; B65D 25/28; B65D 43/02; B65D 51/28

(52) U.S. Cl. CPC B65D 25/20; B65D 25/2891; B65D 51/28; B65D 43/022; B65D 43/0229

(57) ABSTRACT

A Subterranean Storage Container used to store retrievable items beneath the surface of ground, sand, terrain, material, or collection of snow, by means of a helical screw blade around the outside of container. The Subterranean Storage Container is used to store retrievable items. This Subterranean Storage Container encloses with accompanying lid, and may be designed with locking system to provide added security. The Subterranean Storage Container may be used with or without an originally designed towel or fabric, which may attach to Subterranean Storage Container, which is used to cloak and conceal the location of the Subterranean Storage Container from view. The originally designed towel or fabric may be used to store accessories, as drying towel, as wearable towel, as beach towel, or in any creative way the original design may permit.

### CROSS-REFERENCE TO RELATED APPLICATIONS

This application is a continuation of APPLICATION No. 61/965,180, filed Jan. 27, 2014.

### BACKGROUND

Most people go the beach with their wallets, cell phones, money, and other important personal items that would not be left at home. What happens to those items if a person falls asleep or is not paying attention to their belongings while sunbathing? Their personal items can be left in their purse or other baggage they have brought onto the beach with them, they could be wrapped in a towel to put beside them, or they could be concealed in other creative ways in order to keep them accessible and safe. The problem is that these items can still be stolen, even if right from beside a person whilst asleep or not paying attention. The invention of the Subterranean Storage Container provides a solution to the problem by creating a safe space beneath the surface of the ground in a container that screws into ground. The Subterranean storage container may also be combined with a specialized accompanying towel to add further concealment. The benefits of the accompanying towel include: an unsuspecting cloak to conceal location of the Subterranean Storage Container, an optional inflatable neck or head pillow, and a design that includes pockets for easy access to small accessories. The accompanying towel is not necessary to be used with the Subterranean Storage Container; however, it is suggested to work directly with it for added security. The entrance to the Subterranean Storage Container may be concealed by other creative ways. This invention is a theft deterrent because, when used in the suggested manner, the person would have to be physically removed from over the Subterranean Storage Container in order to access it. The Subterranean Storage container's preferred embodiment is designed to be used at the beach to hold smaller personal retrievable items, however, it is not limited to be used only at the beach or to hold the suggested items. The Subterranean storage container could be used in any location where it may be inserted to ground, sand, terrain, material, or a collection of snow to provide a removable storage container for any appropriate items that may fit. This invention can be used to hold numerous items in numerous environments if adjusted to fit certain items and in order to work in numerous environments. The intention, spirit, and scope of the Subterranean Storage Container is to contain retrievable items beneath the surface of ground by screwing the Subterranean Storage Container into ground by the helical screw blade around the outside of the container and enclosing with accompanying lid.

### SUMMARY

The Subterranean Storage Container provides a removable subterranean storage container used to store retrievable items below the surface of the ground. The subterranean containment system is designed to use with an accompanying lid and may also be used with or without an originally designed towel or fabric that conceals the subterranean storage container from view. The towel or fabric is designed with a lined opening to fit securely around the circumference of the subterranean storage container within a space provided for towel or fabric.

### Subterranean Storage Container Therefore

The Subterranean Storage Container provides a removable subterranean storage container that has a helical screw blade around outside of container to screw container into ground in order to conceal and store retrievable items beneath surface of ground.

### DESCRIPTION OF RELATED ART

The included artwork in this non-provisional application covers the spirit and scope of the design from numerous views and perspectives. This artwork does not include measurements or specific material because the measurements and materials are adjustable depending on purpose and environment of use. The artwork includes images of the Subterranean Storage Container with and without the accompanying beach towel because, although it is designed to work with the towel, it may be used without the towel.

FIG. 1: Is an angled perspective of the Subterranean Storage Container, 150, without the lid to reveal the entrance to storage compartment, 151.

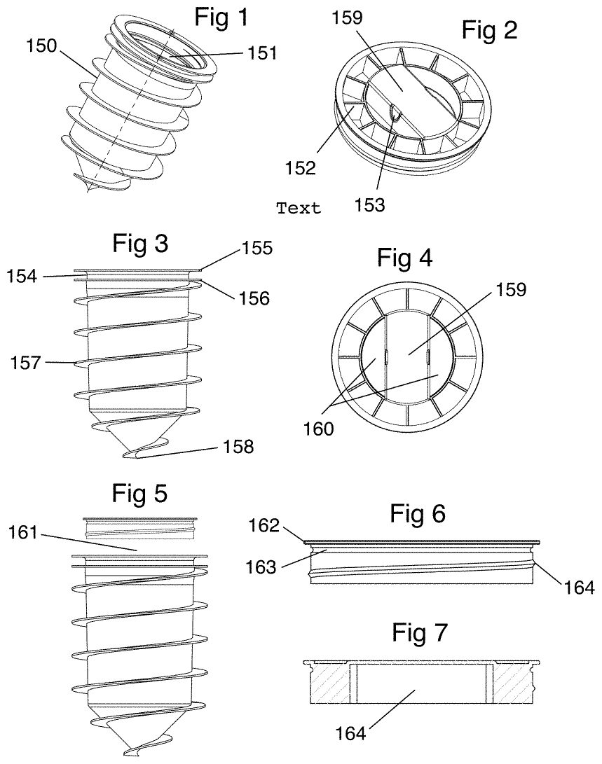

FIG. 2: Is the accompanying lid for the Subterranean Storage Container. This embodiment is designed with structural ribs, 152, to provide structural support. On the sides of the handle, 159, there are indentations, 153, to provide finger grip and to direct user to place fingers on handle in order to remove the lid from the body.

FIG. 3: Is a side view of the Subterranean Storage Container. An inlet, 154, is located between the upper rim, 155, and lower rim, 156, of the body where the optional accompanying towel hole rim, 183, may be fitted. Around the exterior body is the helical screw blade, 157, used to bore into ground, sand, material, or a collection of snow by screwing container in the appropriate direction. At the lowest point of the body is a sharp point, 158, with the lower end of the helical screw blade to break ground when being inserted into untouched surface.

FIG. 4: Is a top view of the Subterranean Storage Container Lid. In the Center of the Lid is a handle, 159, which is used to grip lid by user in order to remove lid from body. On both sides of the handle are inlets, 160, to provide adequate space for users fingers in order to effectively grip the handle.

FIG. 5: Is a side view of the Subterranean Storage Container and Lid illustrating the proper attachment point of lid, 161.

FIG. 6: Is a side view of the Subterranean Storage Container Lid. The top of the lid has a rim, 162, which fits precisely into the body to provide a flush fit that aids in the prevention of elemental damage to the interior stored retrievable items. Beneath the rim is an O-ring inlet, 163, where an O-ring may be added to provide a water resistant barrier to the interior of the body. Around the lower shaft of the lid is a screw thread, 164, used to secure the lid to the body.

FIG. 7: Is a sectional view of the lid. The handle on the lid provides a hollow cavity, 164, within the lid. This cavity provides additional space for taller items that may be stored in the Subterranean Storage Container. It may also be used as a space to attach a power supply, such as a USB flash charger for electronic devices.

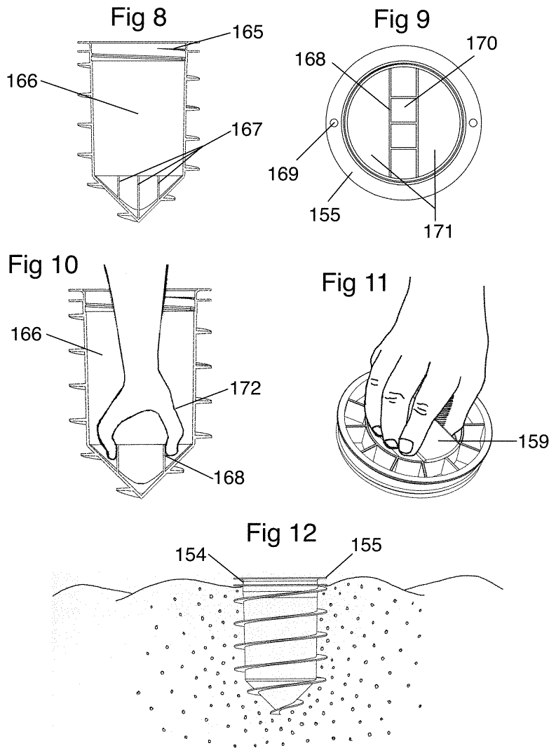

FIG. 8: Is a sectional view of the Subterranean Storage Container body. At the top of the interior compartment are internal threads, 165, to receive the screw threads on lid. In the bottom of the interior storage compartment, 166, are ribs, 167, between the interior lower shaft handle, 168, to provide structural support.

FIG. 9: Is a top view of the Subterranean Storage Container body. The upper rim, 155, has holes, 169, which may be used to attach a carrying or connecting device. The interior storage compartment has a handle, 168, that may be used to grip and provide leverage when screwing the body into ground, sand, material, or a collection of snow. The handle is hollow and provides spaces, 170, for additional storage for small items that may fit. On both side of the handle, are additional spaces, 171, for storage and space for users fingers to effectively grip handle.

FIG. 10: Is a sectional side view of the Subterranean Storage container illustrating the function of the interior storage compartment handle, 168. A user may insert their hand, 172, into the interior storage container, 166, where they can grip the handle, 168, when screwing the body into ground.

FIG. 11: Is an angle view of the Lid illustrating the function of the handle, 159, where a user may grip to screw the lid on or off the Subterranean Storage Container body.

FIG. 12: Shows the Subterranean Storage Container in use beneath the surface of ground, sand, terrain, material, or a collection of snow. The accompanying towel hole rim inlet, 154, and the upper rim of container, 155, are suggested to remain above the surface of ground.

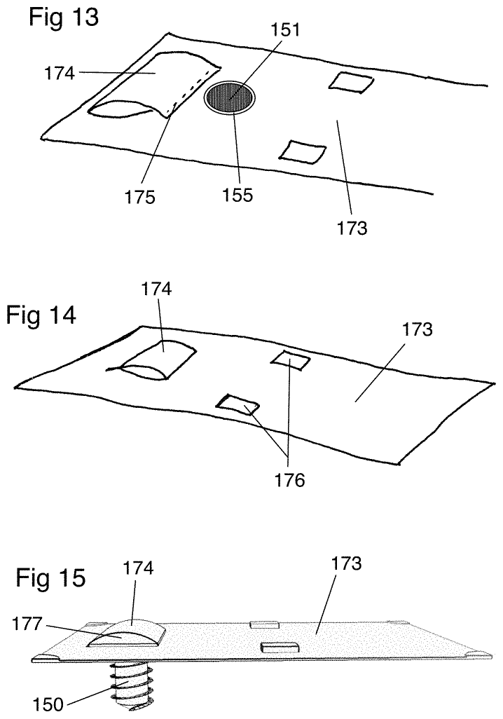

FIG. 13: Is an illustration of the optional accompanying beach towel or fabric, 173, that is suggested to be used with the Subterranean Storage Container, with the pillow sleeve, 174, folded open, to reveal the entrance to the Subterranean Storage Container's compartment, 151. The upper rim of the body, 155, rests on top of the towel. The pillow sleeve is attached to the towel or fabric by being sewed on, 175, in order to be a hinge to fold open and fold close over the entrance to the Subterranean Storage Container.

FIG. 14: Is an illustration of the optional accompanying beach towel or fabric, 173, which is suggested to be used with the Subterranean Storage Container, with the pillow sleeve, 174, folded closed over the entrance to the Subterranean Storage Container's compartment. The towel or fabric has accessory pockets, 176, which provide easy access to items a user might want to have close at hand.

FIG. 15: Is an illustration of the entire assembly of the Subterranean Storage Container, 150, attached to, and in use, beneath the optional accompanying towel or fabric 173. In this illustration, the pillow sleeve, 174, is folded closed over the entrance to the Subterranean Storage Container and is enclosing the optional accompanying inflatable pillow, 177. The inflatable pillow provides a place to rest user's head.

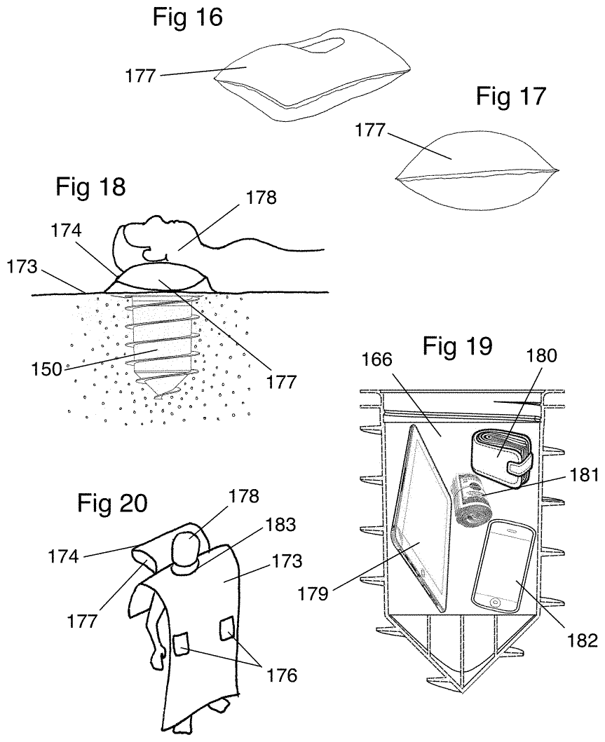

FIG. 16: Is an angled view of the optional accompanying inflatable pillow, 177.

FIG. 17: Is a side view of the optional accompanying inflatable pillow, 177.

FIG. 18: Is an illustration of the Subterranean Storage Container, 150, in use beneath the surface of the ground, attached to, and beneath the optional accompanying towel or fabric, 173. This illustration shows a person using the entire assembly in the suggested manner, which is to have the pillow sleeve, 174, with the enclosed inflatable pillow, 177, folded closed over the entrance to the Subterranean Storage Container, where the user may rest their head, 178, in order to relax and not worry about their valuables being visible or vulnerable to theft.

FIG. 19: Is a sectional view of the Subterranean Storage Container to illustrate the suggested use for the internal storage compartment, 166. This illustration includes valuable items such as a tablet or e-reader, 179, a wallet or purse, 180, currency, 181, and a cellular phone, 182.

FIG. 20: Is an illustration of another embodiment of the optional accompanying towel or fabric, 173. This illustration shows the towel or fabric placed over a user, where the user's head, 178, is inserted through the towel or fabric hole rim, 183. This embodiment provides a wearable towel or fabric where the user may utilize the accessory pockets, 176, and inflatable pillow, 177, which is enclosed within the pillow sleeve, 174.

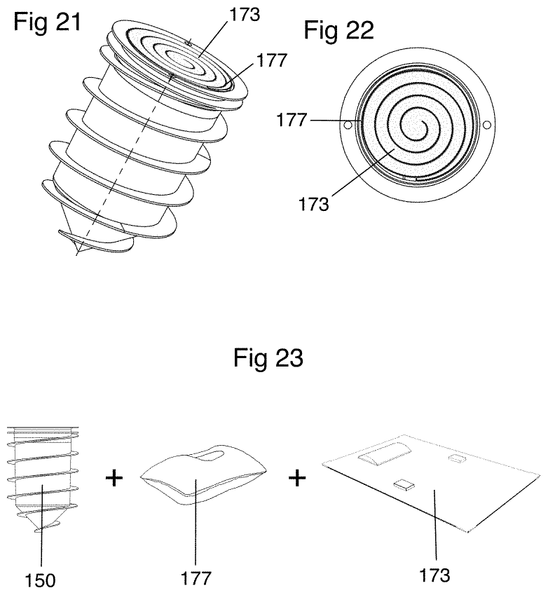

FIG. 21: Is an angle view of the Subterranean Storage Container illustrating the suggested storage for the optional accompanying towel or fabric, 173, and deflated inflatable pillow, 177, when not being used to store retrievable items.

FIG. 22: Is a top view of the Subterranean Storage Container illustrating the suggested storage for the optional accompanying towel or fabric, 173, and deflated inflatable pillow, 177, when not being used to store retrievable items. A Subterranean Storage Container that comes with the towel or fabric may be packaged with the towel or fabric and deflated inflatable pillow within the storage compartment as FIGS. 21 and 22 illustrate.

FIG. 23: Illustrates the Subterranean Storage Container, 150. with the suggested, inflatable pillow, 177, and accompanying towel or fabric, 173. This is the suggested combination of items to be used for the suggested embodiment of use.

### DETAILED DESCRIPTION OF THE SUBTERRANEAN STORAGE CONTAINER

The Subterranean Storage Container is used to contain retrievable items beneath the surface of ground, sand, terrain, material, or a collection of snow (See FIGS. 12, 18, and 19). The Subterranean Storage Container is designed with a helical screw blade around the outside of container to use as a screw to secure removable subterranean storage container in ground and also easily remove from ground. The helical screw blade continues to a point at lowest part of container and can be used to initiate the screwing process of container into untouched material, or into a pre dug cavity (See FIG. 3). Within the inner storage compartment there is a handle near the base of compartment, which can be gripped as handle for leverage when screwing the subterranean storage containment system into the ground (See FIGS. 8, 9, and 10).

The Subterranean Storage Container is designed to work with accompanying lid. This lid has a screw thread around the lower embodiment to screw securely into the subterranean storage container to seal the storage compartment. This lid may also be designed to wedge into opening rather than screw on, and this lid may or may not have a ring washer for tighter seal depending on purpose, environment for use, and security of storage container. (See FIGS. 2, 4, 5, 6, 7, and 11). The Subterranean Storage Container may also be designed to include a locking system in order to provide added security to the Subterranean Storage Container.

The Subterranean Storage Container is designed to work with an originally designed towel or fabric. The originally designed towel has accessory pockets to hold electronic devices or any compatible item with easy accessibility for control. In addition, there is a sewed on sleeve to hold an inflatable pillow (or items that may fit) which folds over opening in the originally designed towel or fabric to conceal access opening to the subterranean storage container (See FIGS. 13, 14, 15, 16, 17, and 18). The inflatable pillow sleeve may be used as head or neck rest, or for propping up items such as electronic devices or books (See FIG. 18). The originally designed towel or fabric may also be used as a wearable towel if user chooses to place head through the towel or fabric hole rim (See FIG. 20). The originally designed towel or fabric is designed to fit within the Subterranean Storage Container Storage Compartment, when not being used to store retrievable items, in order to easily carry Subterranean Storage Container, optional accompanying beach towel or fabric, and optional accompanying inflatable pillow using one hand (See FIGS. 21, 22, and 23).

The preferred embodiment for the Subterranean Storage Container is a plastic subterranean storage container with helical screw blade around outside of container and accompanying lid to be used in a beach environment, with an attached originally designed beach towel or fabric that has an inflatable pillow sleeve to rest head on, and pockets for easy access to accessories.

Another embodiment of the Subterranean Storage Container is a removable subterranean storage container with helical screw blade around outside of container developed with different materials according to the different environments or ground types it will be used in, and sizes according to retrievable items that will be stored within storage compartment. The design is not limited to a single material or size in order to function as a subterranean storage container in any environment it will be used in, or any purpose it will be sued for.

The preferred embodiment of the originally designed towel or fabric is to be used as a cover for subterranean storage container while simultaneously operating as a ground cover to lay, sit, or stand on top. This beach towel or fabric is designed with an attached sleeve to hold inflatable pillow (See FIG. 16). This sleeve is designed to cover opening to subterranean storage container and provide a place to rest head. This beach towel or fabric also has accessory pockets to provide easy access to accessories (See FIGS. 13, 14, 15, and 18).

Another embodiment of the originally designed beach towel or fabric is as a drying towel to be used separately from the subterranean storage container.

Another embodiment of the originally designed towel or fabric is as an overhead, wearable towel when placing persons head through the lined opening, where the inflatable pillow sleeve may also act as a head rest behind a persons head, and accessory pockets may also be used to provide easy access to accessories (See FIG. 20.)

The originally designed towel or fabric is not limited to only towel material, a specific fabric type, or set size specifications, in order to accommodate different environments, ground types, or persons using it.

1. A Subterranean Storage Container comprising: a removable sub terrain storage container with lid that is screwed into ground by helical screw blade around outside of container, in order to contain retrievable items beneath ground, sand, terrain, material, or a collection of snow, which may be used with or without an originally designed towel or fabric, which is designed with accessory pockets, and an inflatable pillow sleeve to fold over and conceal lined opening, which fits the fabric to subterranean storage container.

2. A Subterranean Storage Container as in claim 1, with a handle in bottom of container to provide a handle for leverage so that a person may screw container into or out of ground, sand, terrain, material, or a collection of snow by use of hand.

3. A Subterranean Storage Container as in claim 1, developed to easily insert into ground, terrain, material, or collection of snow and easily be removed.

4. A Subterranean Storage Container as in claim 1, designed with an upper and lower rim with an inlet space between them in order to attach the originally designed towel or fabric hole rim to Subterranean Storage Container, or used in a creative manner the rims and inlet permits.

5. A Subterranean Storage Container as in claim 1, designed with an upper rim, which may have holes, in order to attach a securing or carrying accessory to the Subterranean Storage Container.

6. A Subterranean Storage Container as in claim 1, designed with an upper rim that may be gripped to provide leverage to screw Subterranean Storage Container into or out of ground, sand, terrain, material, or a collection of snow by use of hand.

7. A Subterranean Storage Container as in claim 1, which may be designed with or without a locking system to provide additional security to the Subterranean Storage Container.

8. An originally designed towel or fabric, which may also be used as a wearable towel if user chooses to place head through towel or fabric hole rim.

9. An originally designed towel or fabric as in claim 8, which is designed with a sewed on inflatable pillow sleeve, which folds over the entrance to the Subterranean Storage Container storage compartment, which may enclose pillow so that a user may rest head on pillow while laying on towel.

10. A Subterranean Storage Container as in claim 1, that includes originally designed accompanying screw lid or push on lid, which may also include a ring washer to provide a barrier to elemental damage, to enclose storage compartment.

11. A Subterranean Storage Container as in claim 1, that includes originally designed accompanying screw lid or push on lid, which provides handle on lid to provide grip for user to place secure or remove lid from Subterranean Storage Container.

12. A Subterranean Storage Container as in claim 1, that includes originally designed accompanying screw lid or push on lid, with hollow cavity in the under side of handle, which may be used as additional storage space, or space to attach a power supply such as USB flash charger in order to provide charging power for applicable accessories that may be stored within storage compartment.

13. A Subterranean Storage Container as in claim 1, designed to contain originally designed towel or fabric and inflatable pillow when not being used to store retrievable items, in order to provide a single carrying system for all three items.
Although this invention has been described in specific detail with reference to the disclosed embodiments, it will be understood that many variations and modifications may be effected within the spirit and scope of the invention as described in the appended claims.
